(19) United States
(12) Patent Application Publication
(10) Pub. No.: US 2013/0341427 A1
(43) Pub. Date: Dec. 26, 2013

(54) CARBON DIOXIDE SNOW EJECTING DEVICE

(71) Applicants: Tadashi Ukawa, Matsumoto-shi (JP); Shunichi Magome, Matsumoto-shi (JP); Shinpei Iwamoto, Matsumoto-shi (JP)

(72) Inventors: Tadashi Ukawa, Matsumoto-shi (JP); Shunichi Magome, Matsumoto-shi (JP); Shinpei Iwamoto, Matsumoto-shi (JP)

(73) Assignee: AIR WATER INC., Sapporo-shi, Hokkaido (JP)

(21) Appl. No.: 14/003,618

(22) PCT Filed: Mar. 5, 2012
(86) PCT No.: PCT/JP2012/056212

§ 371 Date: Sep. 6, 2013

(30) Foreign Application Priority Data
Mar. 10, 2011 (JP) 2011-052630

(51) Int. Cl. B05B 7/14

(52) U.S. Cl. CPC B05B 7/1486
USPC 239/290

(57) ABSTRACT

A carbon dioxide snow ejecting device is provided to achieve efficient cleaning by widely ejecting carbon dioxide snow while suppressing consumption loss of carbon dioxide gas. The device includes a carbon dioxide gas supply source for generating carbon dioxide snow, a straightened-flow gas supply source for supplying straightened-flow gas for propelling the carbon dioxide snow, a carbon dioxide snow ejection port 1, and first straightened-flow gas discharge ports 3 incliningly opposing to each other so that the carbon dioxide snow ejection port 1 is located therebetween. The device forms the ejected carbon dioxide snow in a flat shape by the effects of the straightened-flow gas. Thus, unlike conventional techniques, neither loss nor generation of particles will not be caused by the carbon dioxide snow collides the internal surface of a nozzle. Therefore, it is able to prevent situations where loss of carbon dioxide gas and poor cleaning.

### TECHNICAL FIELD

The present invention relates to a carbon dioxide snow ejecting device which can efficiently eject carbon dioxide snow to a wide object.

### BACKGROUND ART

Conventionally, fine carbon dioxide snow generated by adiabatic expansion of liquefied carbon dioxide gas through a choking mechanism such as an orifice or a needle valve is ejected at a point of use while condensing it within a narrow tube to clean an object. Since such carbon dioxide snow cleaning uses the high-purity liquefied carbon dioxide gas as its source gas, it is usable in electronics fields.

In such carbon dioxide snow cleaning, in order to clean a wide object, ejecting the carbon dioxide snow widely according to the object has been studied (for example, the following Patent Documents 1 to 3).

In Patent Document 1, the tip end of an ejection nozzle is formed in a flat shape and in a tapered shape which spreads toward a discharge port, and a notch of a side slit is formed in the tip end of the flat nozzle, i.e., a short side part of the discharge port part.

In Patent Document 2, similar to Patent Document 1, a hollow control cover having the opening in a flat shape is provided, and a notch is formed so that it opens toward the tip end and at both sides of the opening along the long-side axis.

Patent Document 3 discloses that a plurality of ejection nozzles are coupled together in an arrayed fashion.

### REFERENCE DOCUMENTS OF CONVENTIONAL ART

### Patent Documents

Patent Document 1: JP2001-179634A

Patent Document 2: JP2001-340816A

Patent Document 3: JP2004-322007A

### SUMMARY OF THE INVENTION

### Problems to be Solved by the Invention

However, in the ejection nozzles of Patent Documents 1 and 2, there is a problem that, when carbon dioxide snow is ejected, a part of the carbon dioxide snow collides the internal surface of the nozzle, and loss is caused due to the sublimation of the carbon dioxide snow. When the loss of carbon dioxide is caused, a cleaning efficiency over the consumption amount of carbon dioxide gas is reduced and, thus, there is a problem that the carbon dioxide gas is consumed wastefully. In addition, when the part of carbon dioxide snow collides the nozzle, particles are generated and these particles are ejected in a mixed form with the carbon dioxide snow and, thus, there is also a problem that suitable cleaning cannot be achieved. On the other hand, although the wide objects may be cleanable in a short time by the approach of Patent Document 3, the consumption amount of carbon dioxide gas contrarily increases by the increased number of the ejection nozzles and, thus, there is a problem that the cleaning efficiency over the consumption amount of carbon dioxide gas is not high enough. In addition, in the device using the standard nozzle having a double tube structure, a cleaning width is about 2 to 10 mm and, thus, efficient cleaning of the wide objects is difficult.

The present invention is made in view of the above situations, and it provides a carbon dioxide snow ejecting device which achieves an efficient ejection by widely ejecting carbon dioxide snow while suppressing consumption loss of carbon dioxide gas.

### Means for Solving the Problems

In order to achieve the purpose described above, a carbon dioxide snow ejecting device according to the present invention includes a carbon dioxide gas supply source for generating carbon dioxide snow, a straightened-flow gas supply source for supplying straightened-flow gas for propelling the carbon dioxide snow, a carbon dioxide snow ejection port communicating with the carbon dioxide gas source and for ejecting the carbon dioxide snow, and first straightened-flow gas discharge ports communicating with the straightened-flow gas supply source and incliningly opposing to each other so that the carbon dioxide snow ejection port is located therebetween.

### Effects of the Invention

That is, the present invention is provided with the carbon dioxide snow ejection port, and the first straightened-flow gas discharge ports incliningly opposing to each other so that the carbon dioxide snow ejection port is located therebetween.

Thus, the carbon dioxide snow ejected from the carbon dioxide snow ejection port spreads flatly by the effects of the straightened-flow gas discharged from the opposing first straightened-flow gas discharge ports, and then collides the object to be cleaned. As described above, since the ejected carbon dioxide snow is formed in the flat shape by the effects of straightened-flow gas, neither the conventional loss nor generation of particles will be caused by the carbon dioxide snow colliding the internal surface of the nozzle, and it can prevent the situation where the loss of carbon dioxide gas and poor cleaning occur. Thus, efficient and quality cleaning can be achieved while suppressing the consumption loss of carbon dioxide gas.

In the present invention, if the carbon dioxide snow ejection port is arranged at or upstream of the junction of the straightened-flow gas discharged from the opposing first straightened-flow gas discharge ports, carbon dioxide snow is ejected uniformly and widely. That is, since the carbon dioxide snow is solid mixture, the ejecting direction greatly depends on the ejection flow direction immediately after the ejection. However, with the configuration, the discharging direction of the carbon dioxide immediately after ejected from the carbon dioxide snow ejection port follows the gas stream which is formed by joining the straightened-flow gas discharged from the opposing first straightened-flow gas discharge ports, and, therefore, the carbon dioxide snow is ejected uniformly and widely. Thus, the carbon dioxide snow spreads flatly by the effects of the straightened-flow gas discharged from the opposing first straightened-flow gas discharge ports when or after ejected from the carbon dioxide snow ejection port. For this reason, the carbon dioxide snow can effectively be formed in the flat shape, and it is possible to perform the cleaning corresponding to a wider object at a low discharging pressure of the straightened-flow gas.

In the present invention, around the carbon dioxide snow ejection port, a second straightened-flow gas discharge port for discharging straightened-flow gas for preventing clogging of the carbon dioxide snow ejection port is formed annularly. If the carbon dioxide snow ejection port is arranged to project more than the second straightened-flow gas discharge port, the clogging of the carbon dioxide snow in the carbon dioxide snow ejection port or flow passages can be suppressed, the carbon dioxide snow can be continuously and stably ejected, and it can prevent causing of cleaning troubles in advance. Further, the gas stream near the junction of the straightened-flow gas discharged from the first straightened-flow gas discharge ports can prevent that the straightened-flow gas discharged from the first straightened-flow gas discharge ports is disturbed by the second straightened-flow gas discharge port itself or the straightened-flow gas discharged therefrom. Particularly, if the inclination of the first straightened-flow gas discharge ports opposing to each other so that the carbon dioxide snow ejection port is located therebetween is gradual, it can prevent the straightened-flow gas discharged from the first straightened-flow gas discharge ports from being disturbed more significantly by the second straightened-flow gas discharge port itself or the straightened-flow gas discharged therefrom. Further, if the second straightened-flow gas discharge port is projected, it is necessary to increase the interval between the first straightened-flow gas discharge ports incliningly opposing to each other so that the carbon dioxide snow ejection port is located therebetween. Thus, the distance from the respective first straightened-flow gas discharge ports to the junction increases, the flow velocity of the straightened-flow gas is reduced, and the adverse effects on the wide and uniform carbon dioxide snow cannot be avoided. As described above, by arranging the carbon dioxide snow ejection port near the junction so as to project more than the second straightened-flow gas discharge port, it is possible not to cause difficulties of the gas stream, and it is possible to eject wide and uniform carbon dioxide snow.

### BRIEF EXPLANATION OF THE DRAWINGS

FIG. 1 is a cross-sectional view showing one embodiment of a carbon dioxide snow ejection nozzle of the present invention.

FIG. 2 is a view of the carbon dioxide snow ejection nozzle of the present invention seen from an ejection port side.

FIG. 3 is a view illustrating a dimensional relation of a cleaning experiment.

FIG. 4 is a graph showing the results of the cleaning experiment.

### MODES FOR CARRYING OUT THE INVENTION

Below, the best mode for carrying out the invention is described. A carbon dioxide snow ejecting device of this embodiment is configured to include a carbon dioxide gas supply source (not illustrated) for generating carbon dioxide snow, a straightened-flow gas supply source (not illustrated) for supplying straightened-flow gas which propels carbon dioxide snow, and a carbon dioxide snow ejection nozzle which communicates the carbon dioxide gas supply source with the straightened-flow gas supply source, which are described above, and ejects carbon dioxide snow. Specifically, as the carbon dioxide gas supply source described above, a liquefied carbon dioxide gas cylinder or the like may be used. As the straightened-flow gas, nitrogen gas may be used, and as the straightened-flow gas supply source, a liquefied nitrogen tank may be used, for example.

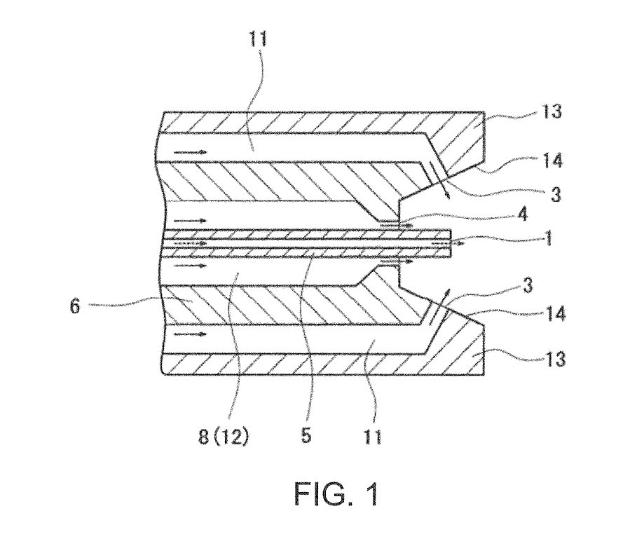

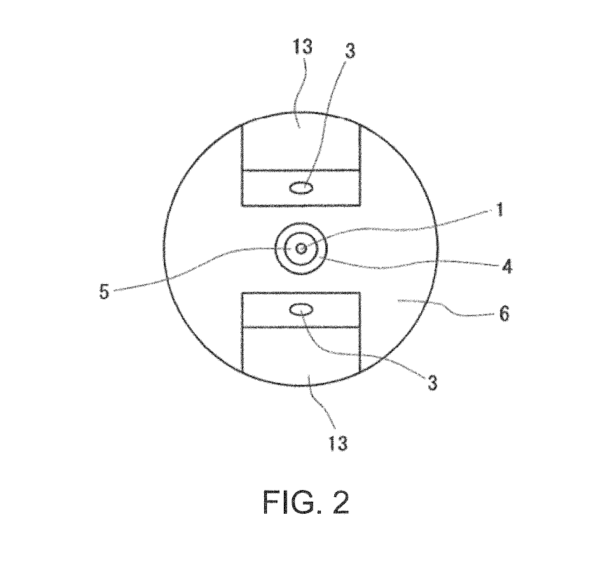

FIG. 1 is a cross-sectional view showing one embodiment of the carbon dioxide snow ejection nozzle to which the present invention is applied, and FIG. 2 is a view thereof seen from an ejection port side.

This carbon dioxide snow ejection nozzle is formed in a substantially cylindrical shape, and at the center of the tip end thereof, a carbon dioxide snow ejection port 1 which communicates with the carbon dioxide gas source and ejects carbon dioxide snow is opened. Further, first straightened-flow gas discharge ports 3 which communicate with the straightened-flow gas supply source and incliningly oppose to each other are formed so that the carbon dioxide snow ejection port 1 is located therebetween.

Describing in more detail, the carbon dioxide snow ejection nozzle is configured to include a nozzle body 6 and a carbon dioxide snow flow conduit 5. Specifically, as the carbon dioxide snow flow conduit 5, a resin tube or a stainless steel tube can be used.

The carbon dioxide snow ejection port 1 is formed as a tip-end opening of the carbon dioxide snow flow conduit 5 through which carbon dioxide snow flows. The carbon dioxide snow flow conduit 5 is arranged to be coaxially inserted in an internal passage 8 of the hollow and cylindrical nozzle body 6. Thus, the internal passage 8 of the nozzle body 6 in which the carbon dioxide snow flow conduit 5 is inserted is formed in a second flow passage 12 where the second straightened-flow gas flows. Further, a second straightened-flow gas discharge port 4 which discharges straightened-flow gas for preventing clogging of the carbon dioxide snow ejection port 1 is annularly formed around the carbon dioxide snow ejection port 1. In order to further prevent the clogging of the carbon dioxide snow ejection port 1, or in order to prevent dew condensation in the nozzle, the second straightened-flow gas may be heated by a heating means, such as a gas heater (not illustrated).

Further, in this example, the internal passage 8 of the nozzle body 6 is set so that its opening diameter of the tip end can be reduced and, therefore, a flow velocity of the straightened-flow gas can be increased by narrowing the area through which the straightened-flow gas flows near the second straightened-flow gas discharge port 4. Note that it is not necessary to narrow the diameter of the tip end opening of the internal passage 8. The carbon dioxide snow flow conduit 5 projects from a tip end face of the nozzle body 6, i.e., the opening of the second straightened-flow gas discharge port 4. Thus, the carbon dioxide snow ejection port 1 is arranged to project more than the second straightened-flow gas discharge port 4.

First flow passages 11 through which the first straightened-flow gas flows are formed in the nozzle body 6. In the tip end face of the nozzle body 6, two projections 13 are formed at locations so that the carbon dioxide snow ejection port 1 is located therebetween, and the internal surfaces of both the projections 13 are formed in sloped surfaces 14 which spread in the ejecting direction while facing toward the carbon dioxide snow ejection port 1. The first straightened-flow gas discharge port 3 communicating with the first flow passage 11 opens in the sloped surface 14, respectively. Thus, the first straightened-flow gas discharge ports 3 oppose to each other so that the carbon dioxide snow ejection port 1 is located therebetween and the first straightened-flow gas discharge ports 3 incline toward the carbon dioxide snow ejection port 1 as well as in the ejecting direction. The straightened-flow gas discharged from the first straightened-flow gas discharge ports 3 are discharged obliquely toward the carbon dioxide snow ejection port 1 and in the ejecting direction. In order to prevent dew condensation due to cooling of an object to be cleaned, the first straightened-flow gas may be heated by a heating means such as a gas heater (not illustrated).

An angle θ of the sloped surface 14 with respect to the discharging direction of the carbon dioxide snow is preferred to be approximately 20°≦θ≦45°. Further, the shape of the first straightened-flow gas discharge port 3 is preferred to be an elongated hole shape or a circular shape.

As described above, since the carbon dioxide snow flow conduit 5 projects more than the tip end face of the nozzle body 6, the carbon dioxide snow ejection port 1 is arranged at or upstream of the junction of straightened-flow gas which is discharged from the opposing first straightened-flow gas discharge ports 3.

The carbon dioxide snow ejection nozzle of this embodiment includes the carbon dioxide snow ejection port 1, and the first straightened-flow gas discharge ports 3 which incliningly oppose to each other so that the carbon dioxide snow ejection port 1 is located therebetween.

For this reason, the carbon dioxide snow ejected from the carbon dioxide snow ejection port 1 spreads flatly by the effects of the straightened-flow gas which is discharged from the opposing first straightened-flow gas discharge ports 3, and then collides the object to be cleaned. Thus, since the ejected carbon dioxide snow is formed in the flat shape by the effects of the straightened-flow gas, there is neither the loss nor the generation of particles due to the carbon dioxide snow colliding the internal surface of the nozzle like happened conventionally and, therefore, the situations where the loss of carbon dioxide gas and poor cleaning occur can be prevented. As described above, efficient and quality cleaning can be achieved while suppressing the consumption loss of carbon dioxide gas.

In addition, since the carbon dioxide snow ejection port 1 is arranged at or upstream of the junction of the straightened-flow gas which is discharged from the opposing first straightened-flow gas discharge ports 3, the carbon dioxide snow is ejected uniformly and widely. That is, since the carbon dioxide snow is solid mixture, its ejecting direction greatly depends on the ejection flow direction immediately after the ejection; however, with this configuration, the ejecting direction of the carbon dioxide immediately after being ejected from the carbon dioxide snow ejection port 1 follows the gas stream which is formed by joining the straightened-flow gas discharged from the opposing first straightened-flow gas discharge ports 1, and, therefore, the carbon dioxide snow is ejected uniformly and widely. As described above, the carbon dioxide snow spreads flatly by the effects of the straightened-flow gas which is discharged from the opposing first straightened-flow gas discharge ports 3 when or after the carbon dioxide snow is ejected from the carbon dioxide snow ejection port 1. For this reason, the carbon dioxide snow can effectively be formed in the flat shape, and it is possible to perform the cleaning suitable for a wider object with a low discharging pressure of the straightened-flow gas.

In addition, the second straightened-flow gas discharge port 4 which discharges the straightened-flow gas for preventing the clogging of the carbon dioxide snow ejection port 1 is annularly formed around the carbon dioxide snow ejection port 1, and the carbon dioxide snow ejection port 1 is arranged to project more than the second straightened-flow gas discharge port 4. Therefore, the clogging of the carbon dioxide snow in the carbon dioxide snow ejection port 1 or the flow passage can be suppressed, the carbon dioxide snow can be stably and continuously ejected and, thus, the occurring of cleaning troubles can be prevented in advance. In addition, the gas stream near the junction of the straightened-flow gas discharged from the first straightened-flow gas discharge ports 3 can prevent that the straightened-flow gas discharged from the first straightened-flow gas discharge ports 3 is disturbed by the second straightened-flow gas discharge port 4 itself or the straightened-flow gas discharged therefrom. Particularly, if the inclination of the opposing first straightened-flow gas discharge ports 3 on both sides of the carbon dioxide snow ejection port 1 is gradual, the second straightened-flow gas discharge port 4 itself or the straightened-flow gas discharged therefrom prevents the straightened-flow gas discharged from the first straightened-flow gas discharge ports 3 from being more significantly disturbed. Further, if the second straightened-flow gas discharge port 4 is projected, it is necessary to increase the interval between the first straightened-flow gas discharge ports 3 which incliningly oppose to each other with respect to the carbon dioxide snow ejection port 1 and, doing so, the distance between the respective first straightened-flow gas discharge ports 3 and the junction increases accordingly, and, therefore, the flow velocity of the straightened-flow gas is reduced and the adverse effects on the wide and uniform carbon dioxide snow cannot be avoided. As described above, by arranging the carbon dioxide snow ejection port 1 near the junction so as to project more than the second straightened-flow gas discharge port 4, it is possible not to cause difficulties of the gas stream, and it is possible to eject wide and uniform carbon dioxide snow.

Further, in this embodiment, a carbon dioxide gas consumption amount becomes 1 to 5 kg/h, and it is possible to effectively and widely eject the carbon dioxide snow.

### Example 1

A cleaning experiment was conducted using the carbon dioxide snow ejection nozzle described in the above embodiment.

A glass substrate was prepared as the object to be cleaned, ink adhered by a permanent marker was removed by the carbon dioxide snow cleaning, and the removed cleaning widths were measured.

### [Experiment Conditions]

Sloped surface angle θ of the first straightened-flow gas discharge ports: 25°
Shape of the first straightened-flow gas discharge ports: 1.6-mm diameter elongated hole structure
Carbon dioxide snow flow conduit outer diameter: 1.6 mm in diameter
Inner diameter of the second straightened-flow gas discharge port: 2.8 mm in diameter
Straightened-flow gas supply pressure: 0.45 MPaG
Liquefied carbon dioxide gas supply pressure: 7.0 MPaG
Cleaning time: 120 sec

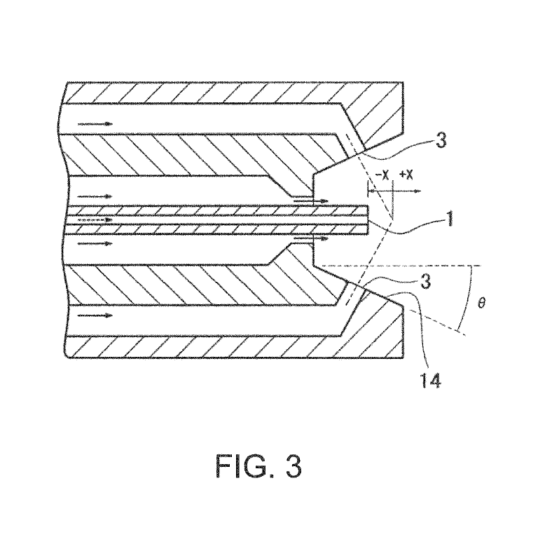

FIG. 3 is a view illustrating the dimensional relation of the cleaning experiment.

The angle θ between each of the sloped surface 14 where the first straightened-flow gas discharge port 3 is formed and the ejecting direction (in this example, it is also the longitudinal direction of the nozzle) was set to 25°.

The distance from the second straightened-flow gas discharge port 4 to the object to be cleaned was set to 25 mm.

The second straightened-flow gas discharge port 4 was fixed at a distance X=−3.5 mm.

In this cleaning experiment, the liquefied carbon dioxide gas was supplied at 4.5 kg/h.

The carbon dioxide snow cleaning was actually carried out, while the distance X (mm) between the junction of the first straightened-flow gas discharged from the first straightened-flow gas discharge port 3 and the carbon dioxide snow ejection port 1 was changed, and the cleaning widths (mm) were measured accordingly. The distance X indicates upstream from the junction if it is −X, and downstream from the junction if it is +X.

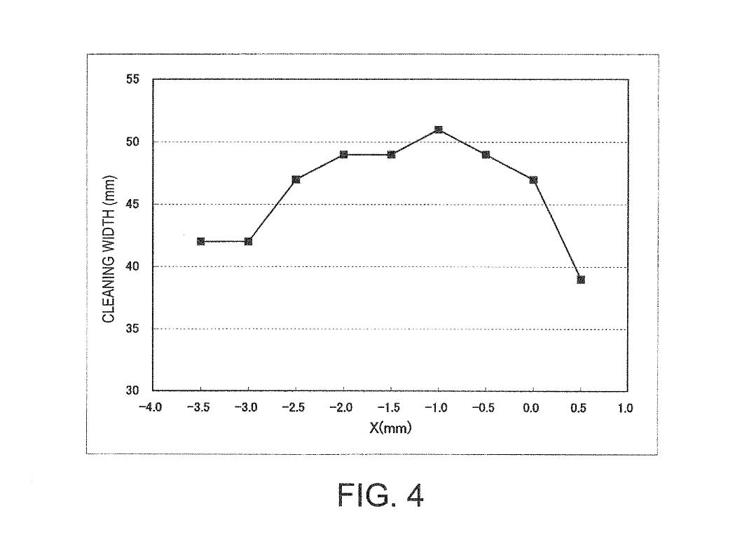

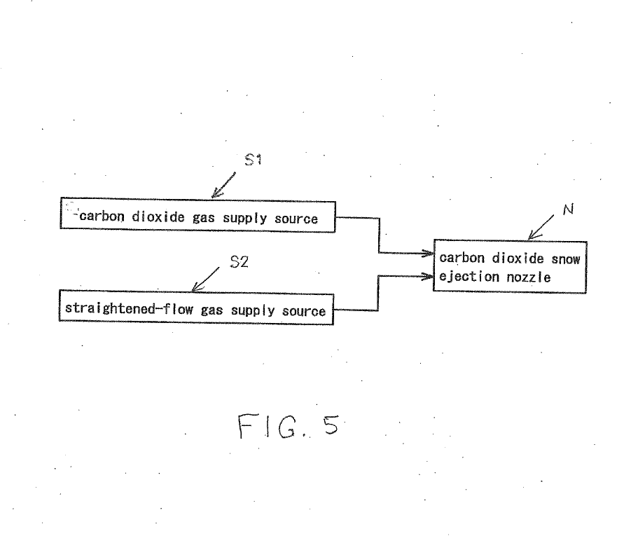

FIG. 4 is a graph showing the results of the cleaning experiment.

As seen from FIG. 4, a range of the distance X is preferred to be −2.5 mm≦X≦0 mm, and more preferred to be −2.0 mm≦X≦−0.5 mm.

### Example 2

A cleaning experiment was conducted so that the second straightened-flow gas discharge port 4 of the carbon dioxide snow ejection nozzle which was used in Example 1 projects together with the carbon dioxide snow flow conduit 5.

The locations of the second straightened-flow gas discharge port 4 and the carbon dioxide snow ejection port 1 were fixed at X=0 mm. The distance from the second straightened-flow gas discharge port 4 to the object to be cleaned was 21.5 mm.

Similar to Example 1, a glass substrate was prepared as the object to be cleaned, ink adhered by the permanent marker was removed by the carbon dioxide snow cleaning, and the removed cleaning widths were measured.

### [Experiment Conditions]

Sloped surface angle θ of the first straightened-flow gas discharge ports: 25°
Shape of the first straightened-flow gas discharge ports: 1.6-mm diameter elongated hole structure
Carbon dioxide snow flow conduit outer diameter: 1.6 mm in diameter
Inner diameter of the second straightened-flow gas discharge port: 2.8 mm in diameter
Outer diameter of the second straightened-flow gas discharge port: 4.0 mm in diameter
Straightened-flow gas supply pressure: 0.45 MPaG
Liquefied carbon dioxide gas supply pressure: 7.0 MPaG
Cleaning time: 120 sec

As a result of conducting the cleaning experiment, the cleaning width was 15 mm.

In Example 1, the second straightened-flow gas discharge port was fixed at the distance X=−3.5 mm, and if the carbon dioxide snow discharge port 1 was at X=0 mm, it was in a state where the carbon dioxide snow ejection port 1 projects more than the second straightened-flow gas discharge port 4. In this case, the cleaning width was 47 mm.

In Example 2, since the second straightened-flow gas discharge port 4 was projected together with the carbon dioxide snow flow conduit 5, it was in a state where the carbon dioxide snow ejection port 1 does not project more than the second straightened-flow gas discharge port 4. In this case, the cleaning width was 15 mm. As described above, it was found that the carbon dioxide snow is ejected widely if the carbon dioxide snow ejection port 1 projects more than the second straightened-flow gas discharge port 4. If the bore diameters of the carbon dioxide snow flow conduit 5 and the second straightened-flow gas discharge port 4 are larger, the turbulence of the first straightened-flow gas increases. Note that, in this embodiment, although the first straightened-flow gas discharge ports 3 were formed so that each one of the first straightened-flow gas discharge ports 3 is located having the carbon dioxide snow ejection port 1 therebetween, it is not limited to this and a plurality of first straightened-flow gas discharge ports 3 may be formed on both sides of the carbon dioxide snow ejection port 1, respectively. Also in this case, similar operations and effects to the above embodiment can be attained. The application of the present invention includes various kinds of objects, such as, for example, electronic substrates, electronic components, sensor devices, flat-panel display substrates, touch panels, semiconductor substrates, semiconductor devices, MEMS, optical components, optical film related articles, printing related articles, magnetic components, semiconductor related articles, metal components, heat exchangers, molds, glass, and foodstuffs. According to the present invention, various kinds of contaminants, such as foreign substances, particles, inorganic substances, or organic substances adhered to the above objects, can be removed. Further, it is also applicable to removing burrs formed on plastic-molded parts. Thus, it intends to include all these forms into the cleaning of the present invention.

### DESCRIPTION OF REFERENCE NUMERALS

1: Carbon Dioxide Snow Ejection Port

3: First Straightened-Flow Gas Discharge Port

4: Second Straightened-Flow Gas Discharge Port

5: Carbon Dioxide Snow Flow Conduit

6: Nozzle Body

8: Internal Passage

11: First Flow Passage

12: Second Flow Passage

13: Projection

14: Sloped Surface

1. A carbon dioxide snow ejecting device, comprising:
a carbon dioxide gas supply source for generating carbon dioxide snow;
a straightened-flow gas supply source for supplying straightened-flow gas for propelling the carbon dioxide snow;
a carbon dioxide snow ejection port communicating with the carbon dioxide gas source and for ejecting the carbon dioxide snow; and
first straightened-flow gas discharge ports communicating with the straightened-flow gas supply source and incliningly opposing to each other so that the carbon dioxide snow ejection port is located therebetween.

2. The carbon dioxide snow ejecting device of claim 1, wherein the carbon dioxide snow ejection port is arranged at or upstream of the junction of the straightened-flow gas discharged from the opposing first straightened-flow gas discharge ports.

3. The carbon dioxide snow ejecting device of claim 1, wherein a second straightened-flow gas discharge port for discharging straightened-flow gas for preventing clogging of the carbon dioxide snow ejection port is formed annularly around the carbon dioxide snow ejection port, and the carbon dioxide snow ejection port projects is arranged to project more than the second straightened-flow gas discharge port.

4. The carbon dioxide snow ejecting device of claim 2, wherein a second straightened-flow gas discharge port for discharging straightened-flow gas for preventing clogging of the carbon dioxide snow ejection port is formed annularly around the carbon dioxide snow ejection port, and the carbon dioxide snow ejection port projects is arranged to project more than the second straightened-flow gas discharge port.
